(19) United States
(12) Patent Application Publication
(10) Pub. No.: US 2025/0016618 A1
(43) Pub. Date: Jan. 9, 2025

(54) METHODS AND APPARATUSES FOR PDCP REORDERING MANAGEMENT

(71) Applicant: LENOVO (BEIJING) LIMITED, Beijing (CN)

(72) Inventors: Mingzeng DAI, Shanghai (CN); Jing HAN, Beijing (CN); Congchi ZHANG, Shanghai (CN); Lianhai WU, Beijing (CN); Haiyan LUO, Shanghai (CN); Yibin ZHUO, Shanghai (CN); Le YAN, Shanghai (CN)

(21) Appl. No.: 18/710,361

(22) PCT Filed: Nov. 16, 2021
(86) PCT No.: PCT/CN2021/130968

§ 371 Date: May 15, 2024

(51) Int. Cl. H04W 28/06; H04L 47/34

(52) U.S. Cl. CPC H04W 28/06; H04L 47/34

(57) ABSTRACT

Embodiments of the present disclosure relate to methods and apparatuses for packet data convergence protocol (PDCP) reordering management. According to an embodiment of the present disclosure, a user equipment (UE) can include: a receiver configured to receive at least one of application data unit (ADU) discard information associated with an ADU or ADU related information associated with the ADU; and a processor coupled to the receiver and configured to perform a PDCP reordering window management based on the received at least one of the ADU discard information or the ADU related information.

### TECHNICAL FIELD

Embodiments of the present application generally relate to wireless communication technology, and especially to methods and apparatuses for packet data convergence protocol (PDCP) reordering management.

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, application and traffic awareness in radio access network (RAN) is one of key feature to improve user experience of XR services.

The minimum granularity of application data of XR services may be referred to as an application data unit (ADU). XR services require high bit rate with bounded latency. The high bit rates may lead to that a large ADU will be transmitted in several IP packets. For a downlink (DL) data transmission of XR services, in some cases, the network and the user equipment (UE) may decide to drop all packets of an ADU or drop some packets of an ADU. However, the current PDCP reordering window management scheme is inefficient to support ADU based packet dropping.

Given the above, it is desirable to provide improved technology for PDCP reordering management, which can support ADU based packet dropping.

### SUMMARY OF THE DISCLOSURE

Embodiments of the present application at least provide a technical solution for PDCP reordering management.

According to some embodiments of the present application, a method perform by a UE may include: receiving at least one of ADU discard information associated with an ADU or ADU related information associated with the ADU; and performing a PDCP reordering window management based on the received at least one of the ADU discard information or the ADU related information.

In some embodiments of the present application, the ADU discard information is received via a radio resource control (RRC) signalling or received via a PDCP control protocol data unit (PDU).

In some embodiments of the present application, the ADU discard information includes one or more numbers of one or more packets of the ADU.

In some embodiments of the present application, a number of a packet is a PDCP sequence number (SN) or a PDCP count value.

In some embodiments of the present application, wherein the method further includes: discarding all stored packets with numbers included in the ADU discard information, and wherein performing a PDCP reordering window management includes: updating an RX_DELIV value to a COUNT value of a first packet which has not been delivered to upper layers but still waited for and is not indicated to be discarded by the ADU discard information; updating an RX_NEXT value to a COUNT value of a next packet expected to be received excluding the one or more packets that are indicated to be discarded by the ADU discard information; restarting a reordering timer in the case that the updated RX_DELIV value is less than the updated RX_NEXT value; and stopping the reordering timer in the case that the updated RX_DELIV value equals to the updated RX_NEXT value.

In some embodiments of the present application, the ADU related information includes one number of the ADU and numbers of all the packets included in the ADU, and wherein the ADU discard information includes the number of the ADU to be discarded.

In some embodiments of the present application, wherein the method further includes discarding all stored packets associated with the ADU indicated by the ADU discard information, and wherein performing a PDCP reordering window management includes: updating an RX_DELIV value to a COUNT value of a first packet which has not been delivered to upper layers but still waited for and is not a part of the ADU indicated by the ADU discard information; updating an RX_NEXT value to a COUNT value of a next packet expected to be received excluding all the packets which are part of the ADU indicated by the ADU discard information; restarting a reordering timer in the case that the updated RX_DELIV value is less than the updated RX_NEXT value; and stopping the reordering timer in the case that the updated RX_DELIV value equals to the updated RX_NEXT value.

In some embodiments of the present application, wherein the ADU related information further includes an importance indication for each packet included in the ADU, wherein the importance indication indicates whether the packet is a critical packet or a non-critical packet, and wherein the ADU discard information includes the number of the ADU to be discarded and critical discard information which indicates whether critical packets of the ADU need to be discarded or whether only non-critical packets of the ADU need to be discarded.

In some embodiments of the present application, wherein the method further includes discarding all stored non-critical packets associated the ADU indicated by the ADU discard information in the case that the critical discard information indicates only non-critical packets of the ADU need to be discarded, and wherein performing a PDCP reordering window management includes: updating an RX_DELIV value to a COUNT value of a first packet which has not been delivered to upper layers but still waited for and is not a non-critical packet of the ADU indicated by the ADU discard information; updating an RX_NEXT value to a COUNT value of a next packet expected to be received excluding all the non-critical packets of the ADU indicated by the ADU discard information; restarting a reordering timer in the case that the updated RX_DELIV value is less than the updated RX_NEXT value; and stopping the reordering timer in the case that the updated RX_DELIV value equals to the updated RX_NEXT value.

In some embodiments of the present application, the ADU related information is received in a layer 2 header, or received via a RRC signalling, or received via a medium access control (MAC) control element (CE), or received via a PDCP control PDU.

In some embodiments of the present application, the ADU related information includes one number of the ADU, numbers of all the packets included in the ADU, and an importance indication for each packet included in an ADU, wherein the importance indication indicate whether the packet is a critical packet or a non-critical packet.

In some embodiments of the present application, the method further includes: receiving a first PDCP reordering window configuration for non-critical packets in the ADU, wherein the first PDCP reordering window configuration includes a first reordering timer.

In some embodiments of the present application, the method further includes: receiving a second PDCP reordering window configuration for critical packets in the ADU, wherein the first PDCP reordering window configuration includes a second reordering timer.

In some embodiments of the present application, the method further includes: starting a first reordering timer in the case that a non-critical packet of the ADU is not received and an out of order reception happens to the non-critical packet; starting a second reordering timer in the case that a critical packet of the ADU is not received and an out of order reception happens to the critical packet.

In some embodiments of the present application, in the case that the critical packet is received when the second reordering timer is running, the method further includes: stopping or restart the second reordering timer; in the case that the first reordering timer is running: updating an RX_DELIV value to a COUNT value of a first packet which has not been delivered to upper layers but still waited for; and in the case that the first reordering timer expires: treating all the missing non-critical packets of the ADU as having been received; and updating an RX_DELIV to a COUNT value of the first packet which has not been delivered to upper layers but still waited for excepting all the packets treated as having been received.

In some embodiments of the present application, in the case that the critical packet is not received and the second reordering timer expires, the method further includes: stopping the first reordering timer; and discard all stored packets of the ADU associated with the critical packet.

In some embodiments of the present application, the second reordering timer is set to zero.

In some embodiments of the present application, a second reordering timer for critical packets in the ADU is absent.

In some embodiments of the present application, the method further includes: delivering a critical packet directly to upper layers when receiving it from lower layers without performing a PDCP reordering window management for the critical packet.

In some embodiments of the present application, the first PDCP reordering window configuration further includes a first RX_DELIV value and a first RX_NEXT value, and wherein the second PDCP reordering window configuration further includes a second RX_DELIV value and a second RX_NEXT value.

According to some embodiments of the present application, a method perform by a base station (BS) may include: transmitting at least one of ADU discard information associated with an ADU or ADU related information associated with the ADU, wherein the transmitted at least one of the ADU discard information or the ADU related information is used for performing a PDCP reordering window management.

In some embodiments of the present application, the ADU discard information is transmitted via a RRC signalling or transmitted via a PDCP control PDU.

In some embodiments of the present application, the ADU discard information includes one or more numbers of one or more packets of the ADU.

In some embodiments of the present application, a number of a packet is a PDCP SN or a PDCP count value.

In some embodiments of the present application, the ADU related information includes one number of the ADU and numbers of all the packets included in the ADU, and wherein the ADU discard information includes the number of the ADU to be discarded.

In some embodiments of the present application, wherein the ADU related information further includes an importance indication for each packet included in the ADU, wherein the importance indication indicates whether the packet is a critical packet or a non-critical packet, and wherein the ADU discard information includes the number of the ADU to be discarded and critical discard information which indicates whether critical packets of the ADU need to be discarded or whether only non-critical packets of the ADU need to be discarded.

In some embodiments of the present application, the ADU related information is transmitted in a layer 2 header, or received via a RRC signalling, or received via a MAC CE, or received via a PDCP control PDU.

In some embodiments of the present application, the ADU related information includes one number of the ADU, numbers of all the packets included in the ADU, and an importance indication for each packet included in an ADU, wherein the importance indication indicate whether the packet is a critical packet or a non-critical packet.

In some embodiments of the present application, the method further includes: transmitting a first PDCP reordering window configuration for non-critical packets in the ADU, wherein the first PDCP reordering window configuration includes a first reordering timer.

In some embodiments of the present application, the method further includes: transmitting a second PDCP reordering window configuration for critical packets in the ADU, wherein the first PDCP reordering window configuration includes a second reordering timer.

In some embodiments of the present application, the second reordering timer is set to zero.

In some embodiments of the present application, a second reordering timer for critical packets in the ADU is absent.

In some embodiments of the present application, the first PDCP reordering window configuration further includes a first RX_DELIV value and a first RX_NEXT value, and wherein the second PDCP reordering window configuration further includes a second RX_DELIV value and a second RX_NEXT value.

Some embodiments of the present application also provide a UE, including: a receiver configured to: receive at least one of ADU discard information associated with an ADU or ADU related information associated with the ADU; and a processor coupled to the receiver and configured to: perform a PDCP reordering window management based on the received at least one of the ADU discard information or the ADU related information.

Some other embodiments of the present application also provide a BS, including: a transmitter configured to: transmit at least one of ADU discard information associated with an ADU or ADU related information associated with the ADU, wherein the transmitted at least one of the ADU discard information or the ADU related information is used for performing a PDCP reordering window management.

Embodiments of the present application provide a technical solution for PDCP reordering management, which can support ADU based packet dropping.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary PDCP reordering management scheme according to some embodiments of the present application;

FIG. 3 illustrates an exemplary flowchart of a method for PDCP reordering management according to some embodiments of the present application;

FIG. 4 illustrates an exemplary PDCP reordering management scheme according to some embodiments of the present application;

FIG. 5 illustrates another exemplary PDCP reordering management scheme according to some other embodiments of the present application;

FIG. 6 illustrates another exemplary flowchart of a method for PDCP reordering management according to some other embodiments of the present application; and

FIG. 7 illustrates a simplified block diagram of an apparatus for PDCP reordering management according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G (i.e., new radio (NR)), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

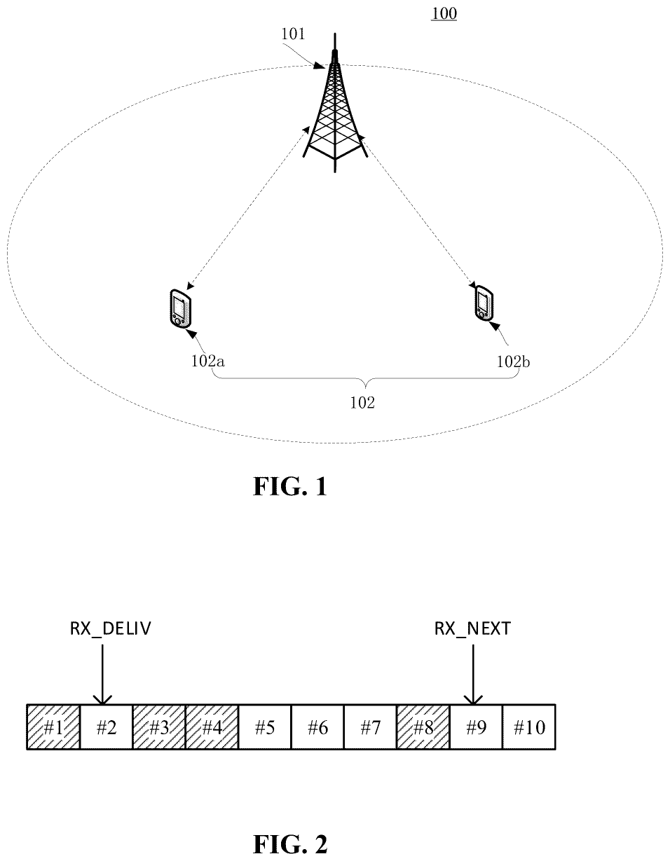

FIG. 1 is a schematic diagram illustrating an exemplary wireless communication system 100 according to some embodiments of the present application.

As shown in FIG. 1, the wireless communication system 100 includes at least one base station (BS) 101 and at least one UE 102. In particular, the wireless communication system 100 includes one BS 101 and two UEs 102 (e.g., a UE 102a and a UE 102b) for illustrative purpose. Although a specific number of BS 101 and UEs 102 are depicted in FIG. 1, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as a NG-RAN node, a RAN node, an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

According to some embodiments of the present application, the UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 102 may include wearable devices, such as smart watches, fitness bands, optical head-mounted displays, or the like.

Moreover, the UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 may transmit information to the BS 101 and receive control information from the BS 101, for example, via LTE or NR Uu interface.

XR, including AR and VR, as well as CG, presents a new promising category of connected devices, applications, and services. A UE with an XR service can be referred to as an XR device. As a potential working area of 3 GPP Rel-18, application and traffic awareness in RAN is one of key feature to improve user experience of XR services.

Typically, the minimum granularity of application data of XR services may be referred to as an ADU. XR services may require high bit rate with bounded latency. The high bit rates lead to that a large ADU will be transmitted in several IP packets. When these IP packets arrive at RAN, RAN will treat all the packets as if they are uncorrelated with each other. If one IP packet belonging to one particular ADU is too late, dropping all relevant IP packets which are already arrived at RAN may be beneficial, because doing so can avoid redundant transmissions of IP packets belonging to the particular ADU which may not be used for rendering anyway. Dropping packets which arrive at RAN too late can save expensive radio resource so that the resource can be used for other users, which potentially increases the overall system capacity.

In some embodiments, the ADU may represent groups of pictures (GOPs) for e.g. video service. The GOPs are grouped together in ways that enhance the visual result of a video sequence. The GOPs may include various types of pictures, such as intra-coded picture frame (i.e., I-frame), predictive coded picture frame (i.e., P-frame), Bi-predictive coded picture frame (i.e., B-frame), etc. Encoders use GOPs and other tools to render smoothly streaming video.

In some embodiments of the present application, when a PDCP entity receives data packets, the PDCP entity may submit the data packets to upper layers (e.g., the layers higher than PDCP layer) in a continuous ascending order of the PDCP count values. If the count value is not continuous, the PDCP entity may use a PDCP reordering management scheme to monitor the arrival of the missing data packets.

FIG. 2 illustrates an exemplary PDCP reordering management scheme according to some embodiments of the present application. In the example of FIG. 2, the PDCP reordering management scheme may involve four parameters, including:
RX_NEXT: this state variable indicates the COUNT value of the next PDCP SDU expected to be received;
RX_DELIV: this state variable indicates the COUNT value of the first PDCP SDU not delivered to the upper layers, but still waited for;
RX_REORD: this state variable indicates the COUNT value following the COUNT value associated with the PDCP Data PDU which triggered t-Reordering; and
t-Reordering, this parameter is a PDCP reordering timer, the duration of the timer is configured by an RRC signalling.

Referring to FIG. 2, it is assumed that PDCP SDUs with count values (or sequence numbers) #1, #3, #4, and #8 are received at the PDCP layer, whereas PDCP SDUs with count values (or sequence numbers) #2, #5, #6, #7, #9, and #10 are not received at the PDCP layer. Then, RX_NEXT is #9 and RX_DELIV is #2. Since RX_DELIV<RX_NEXT, the UE may start the timer t-Reordering when it receives PDCP SDU #3.

When the timer t-Reordering is running, the UE waits for the packet(s) with associated COUNT value of RX_DELIV and does not deliver the stored PDCP SDUs to upper layer due to in-order delivery. When 1-Reordering expires, the receiving PDCP entity may deliver to the upper layer all stored PDCP SDUs with associated COUNT value(s)<RX_REORD and all stored PDCP SDU(s) with consecutively associated COUNT value(s) starting from RX_REORD.

For a DL data transmission of XR services. In some cases, for example, the packets come too late from core network, the packets are out of date due to that the quality of service (QOS) cannot be satisfied, or network congestion, the network and the UE may decide to drop all relevant IP packets of an ADU or drop some non-critical packets of an ADU (e.g. B-frames and/or P-frames of video service). Then, how to determine the packets of an ADU to be dropped need to be addressed.

In addition, the PDCP reordering window management scheme in FIG. 2 may be inefficient to support ADU based packet dropping. This is because in FIG. 2, the PDCP reordering window can only move forward after the timer t-Reordering expires if one or more packets of an ADU are received and the other packets are not received. Given this, to avoid unnecessary waiting time, a more efficient PDCP reordering window management scheme for ADU based packet dropping needs to be designed for XR services.

Given the above, embodiments of the present application propose methods for PDCP reordering management, which can at least solve the above two problems (e.g., how to determine the packets of an ADU to be dropped and how to provide a more efficient PDCP reordering window management scheme for ADU based packet dropping. More details on embodiments of the present application will be illustrated in the following text in combination with the appended drawings.

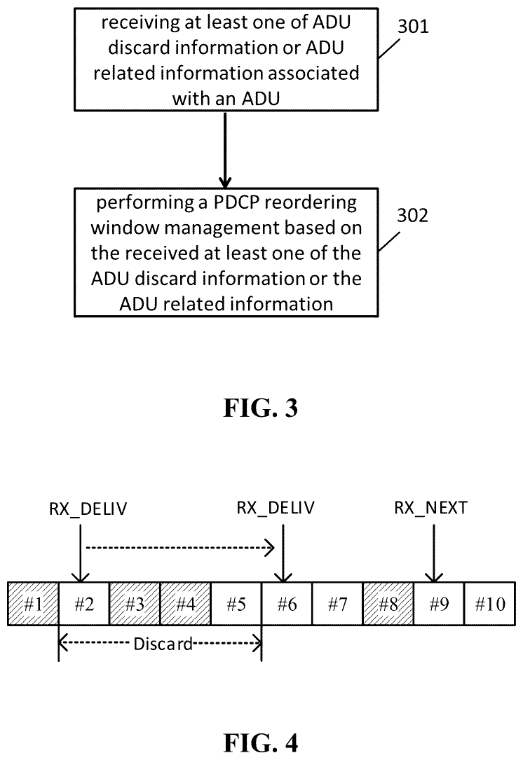

FIG. 3 illustrates an exemplary flowchart of a method for PDCP reordering management according to some embodiments of the present application. The method illustrated in FIG. 3 may be performed by a UE (e.g., the UE 102a or 102b as shown in FIG. 1). Persons skilled in the art can understand that the method described with respect to the UE can be implemented by other apparatus with the like functions.

In the exemplary embodiments shown in FIG. 3, in step 301, the UE may receive at least one of ADU discard information associated with an ADU or ADU related information associated with the ADU from a BS (e.g., BS 101 as shown in FIG. 1). Then, in step 302, based on the received at least one of the ADU discard information or the ADU related information, the UE may perform a PDCP reordering window management.

In some embodiments of the present application, the ADU may represent GOPs for video service. The GOPs may include various types of pictures, such as intra-coded picture frame (i.e., I-frame), predictive coded picture frame (i.e., P-frame), Bi-predictive coded picture frame (i.e., B-frame), etc.

According to some embodiments of the present application, when the BS decides to drop packets of an ADU (e.g. in case that the packets come too late from core network, or the packets are out of date due to that the QoS cannot be satisfied, or network congestion), the BS may transmit the ADU discard information to the UE. Consequently, the UE may receive the ADU discard information from the BS, then the UE may perform the PDCP reordering window management at least based on the ADU discard information.

In some embodiments of the present application, the ADU discard information may be received via a RRC signalling or received via a PDCP control PDU, e.g., the ADU discard information may be received in a PDCP SDU discard command.

In some embodiments of the present application, the ADU discard information includes one or more numbers of one or more packets of the ADU. In such embodiments, the UE may not receive the ADU related information, and thus the UE performs the PDCP reordering window management only based on the ADU discard information and not based on the ADU related information.

In an embodiment of the present application, a packet of the ADU may be a PDCP PDU or a PDCP SDU. In another embodiment of the present application, a number of a packet may be a PDCP SN or a PDCP count value.

Then, after receiving the ADU discard information including one or more numbers of the one or more packets, the UE may discard all stored packets with numbers included in the ADU discard information and perform the PDCP reordering window management based on the ADU discard information. For example, performing the PDCP reordering window management may include:
updating an RX_DELIV value to a COUNT value of a first packet which has not been delivered to upper layers (i.e., the one or more layers higher than the PDCP layer) but still waited for and is not indicated to be discarded by the ADU discard information;
updating an RX_NEXT value to a COUNT value of a next packet expected to be received excluding the one or more packets that are indicated to be discarded by the ADU discard information;
restarting a reordering timer in the case that the updated RX_DELIV value is less than the updated RX_NEXT value; and
stopping the reordering timer in the case that the updated RX_DELIV value equals to the updated RX_NEXT value.

FIG. 4 illustrates an exemplary PDCP reordering management scheme according to some embodiments of the present application.

Referring to FIG. 4, it is assumed that PDCP SDUs with count values #1, #3, #4, and #8 are received at the PDCP layer, whereas PDCP SDUs with count values #2, #5, #6, #7, #9, and #10 are not received at the PDCP layer. Then, RX_NEXT is #9 and RX_DELIV is #2. Since RX_DELIV<RX_NEXT, the UE may start the timer t-Reordering when PDCP SDU with count value #3 is received.

Moreover, it is assumed that the ADU includes PDCP SDUs (or PDCP PDUs) with count values (or SNs) #2, #3, #4, and #5. When the BS decides to drop all the packets of the ADU, the BS may send the ADU discard information to the UE. The ADU discard information may include count values #2, #3, #4, and #5, which indicates that the PDCP SDUs with count values #2, #3, #4, and #5 need to be discarded. After receiving the ADU discard information, the UE may:
discard the stored PDCP SDUs with COUNT value indicated in the ADU discard information, i.e. the PDCP SDU #3 and PDCP SDU #4 in this example.
update an RX_DELIV value to a COUNT value of a first packet which has not been delivered to upper layers but still waited for and is not indicated to be discarded by the ADU discard information, i.e., #6 in this example;
update an RX_NEXT value to a COUNT value of a next packet expected to be received excluding the one or more packets that are indicated to be discarded by the ADU discard information, i.e., #9 in this example. That is, The RX_NEXT is unchanged in this example.
restart the t-Reordering timer because the updated RX_DELIV value is less than the updated RX_NEXT value.

In another example, it is assumed that the ADU includes PDCP SDUs with count values #3, #4, and #5. When the BS decides to drop all the packets of the ADU, the BS may send the ADU discard information to the UE. The ADU discard information may include count values #3, #4, and #5, which indicates that the PDCP SDUs with count values #3, #4, and #5 need to be discarded. After receiving the ADU discard information, the UE may:
discard the stored PDCP SDUs with COUNT value indicated in the ADU discard information, i.e. the PDCP SDU #3 and PDCP SDU #4 in this example.
update an RX_DELIV value to a COUNT value of a first packet which has not been delivered to upper layers but still waited for and is not indicated to be discarded by the ADU discard information, i.e., if the PDCP SDU with count value #2 is still not received, keep RX_DELIV as #2; if the PDCP SDU with count value #2 is received, update the RX_DELIV to #6;
update an RX_NEXT value to a COUNT value of a next packet expected to be received excluding the one or more packets that are indicated to be discarded by the ADU discard information, i.e., #9 in this example. That is, The RX_NEXT is unchanged in this example.
restart the t-Reordering timer because the updated RX_DELIV value is less than the updated RX_NEXT value.

In another example, it is assumed that the ADU includes PDCP SDUs with count values #2, #3, #4, #5, #6, #7, and #8. When the BS decides to drop all the packets of the ADU, the BS may send the ADU discard information to the UE. The ADU discard information may include count values #2, #3, #4, #5, #6, #7, and #8, which indicates that the PDCP SDUs with count values #2, #3, #4, #5, #6, #7, and #8 need to be discarded. After receiving the ADU discard information, the UE may:
discard the stored PDCP SDUs with COUNT value indicated in the ADU discard information, i.e. the PDCP SDU #3, PDCP SDU #4, and PDCP SDU #8 in this example.
update an RX_DELIV value to a COUNT value of a first packet which has not been delivered to upper layers but still waited for and is not indicated to be discarded by the ADU discard information, i.e., #9 in this example #2;
update an RX_NEXT value to a COUNT value of a next packet expected to be received excluding the one or more packets that are indicated to be discarded by the ADU discard information, i.e., #9 in this example. That is, The RX_NEXT is unchanged in this example.
stop the t-Reordering timer because the updated RX_DELIV value is equal to the updated RX_NEXT value.

In some other embodiments of the present application, the UE may receive both the ADU related information and the ADU discard information. In such embodiments, the ADU related information may include one number of the ADU and numbers of all the packets included in the ADU. The number of the ADU may be a sequence number of the ADU or any other number of the ADU which can be used to identify the ADU. A number of a packet in ADU may be a SN of the packet or a count value of the packet.

In an embodiments of the present application, the ADU related information may be received in a layer 2 header (e.g., in a radio link control (RLC) header or a PDCP header or a MAC header), or received via a RRC signalling, or received via a MAC CE, or received via a PDCP control PDU. Then, after receiving the ADU related information, the UE may know the ADU includes which packets or which packets are included in the ADU.

In such embodiments, since the UE knows the ADU related information, the ADU discard information transmitted by the BS may merely include the number of the ADU to be discarded.

Then, after receiving the ADU discard information including the number of the ADU, the UE may discard all stored packets associated with the ADU indicated by the ADU discard information and perform the PDCP reordering window management based on the ADU discard information and the ADU related information. For example, performing the PDCP reordering window management may include:
updating an RX_DELIV value to a COUNT value of a first packet which has not been delivered to upper layers but still waited for and is not a part of the ADU indicated by the ADU discard information;
updating an RX_NEXT value to a COUNT value of a next packet expected to be received excluding all the packets which are part of the ADU indicated by the ADU discard information;
restarting a reordering timer in the case that the updated RX_DELIV value is less than the updated RX_NEXT value; and
stopping the reordering timer in the case that the updated RX_DELIV value equals to the updated RX_NEXT value.

For example, referring to FIG. 4, it is assumed that PDCP SDUs with count values #1, #3, #4, and #8 are received at the PDCP layer, whereas PDCP SDUs with count values #2, #5, #6, #7, #9, and #10 are not received at the PDCP layer. Then, RX_NEXT is #9 and RX_DELIV is #2. Since RX_DELIV<RX_NEXT, the UE may start the timer t-Reordering when PDCP SDU with count value #3 is received.

Moreover, it is assumed that the ADU #3 includes PDCP SDUs with count values #2, #3, #4, and #5. The BS may transmit the ADU related information to the UE, the ADU related information may include the number of the ADU to be discarded (i.e., #3) and count values #2, #3, #4, and #5. When the BS decides to drop all the packets of the ADU, the BS may send the ADU discard information to the UE. The ADU discard information may include the number of ADU to be discarded, i.e., #3. After receiving the ADU discard information, the UE may:
determine the count value of packets of the ADU according to the ADU related information. In this example, the UE determines that the ADU #3 includes PDCP SDUs with count values #2, #3, #4, and #5;
discard all stored packets associated with the ADU indicated by the ADU discard information, i.e. the PDCP SDU #3 and PDCP SDU #4 in this example;
update an RX_DELIV value to a COUNT value of a first packet which has not been delivered to upper layers but still waited for and is not a part of the ADU indicated by the ADU discard information, i.e., #6 in this example;
update an RX_NEXT value to a COUNT value of a next packet expected to be received excluding all the packets which are part of the ADU indicated by the ADU discard information, i.e., #9 in this example;
restart the t-Reordering timer because the updated RX_DELIV value is less than the updated RX_NEXT value.

In another example, it is assumed that the ADU #3 includes PDCP SDUs with count values #3, #4, and #5. When the BS decides to drop all the packets of the ADU, the BS may send the ADU discard information to the UE. The ADU discard information may include the number of ADU to be discarded, i.e., #3. After receiving the ADU discard information, the UE may:
determine the count value of packets of the ADU according to the ADU related information. In this example, the UE determines that the ADU #3 includes PDCP SDUs with count values #3, #4, and #5;
discard all stored packets associated with the ADU indicated by the ADU discard information, i.e. the PDCP SDU #3 and PDCP SDU #4 in this example;
update an RX_DELIV value to a COUNT value of a first packet which has not been delivered to upper layers but still waited for and is not a part of the ADU indicated by the ADU discard information, i.e., #2 if the PDCP SDU with count value #2 is still not received; #6 if the PDCP SDU with count value #2 is received;
update an RX_NEXT value to a COUNT value of a next packet expected to be received excluding all the packets which are part of the ADU indicated by the ADU discard information, i.e., #9 in this example;
restart the t-Reordering timer because the updated RX_DELIV value is less than the updated RX_NEXT value.

In another example, it is assumed that the ADU includes PDCP SDUs with count values #2, #3, #4, #5, #6, #7, and #8. When the BS decides to drop all the packets of the ADU, the BS may send the ADU discard information to the UE. The ADU discard information may include the number of ADU to be discarded, i.e., #3. After receiving the ADU discard information, the UE may:
determine the count value of packets of the ADU according to the ADU related information. In this example, the UE determines that the ADU #3 includes PDCP SDUs with count values #2, #3, #4, #5, #6, #7, and #8;
discard all stored packets associated with the ADU indicated by the ADU discard information, i.e. the PDCP SDU #3 and PDCP SDU #4 in this example;
update an RX_DELIV value to a COUNT value of a first packet which has not been delivered to upper layers but still waited for and is not a part of the ADU indicated by the ADU discard information, i.e., #9 in this example;
update an RX_NEXT value to a COUNT value of a next packet expected to be received excluding all the packets which are part of the ADU indicated by the ADU discard information, i.e., #9 in this example;
stop the t-Reordering timer because the updated RX_DELIV value is equal to the updated RX_NEXT value.

In some other embodiments of the present application, within an ADU, different packets may have different importance. For example, an ADU of video service can include multiple frames: I-frame (i.e., intra-coded frame), P-frame (i.e., predictive coded picture frame) and B-frame (bi-predictive coded picture frame). Different frame may have different importance, for example, I-frame is more important than the P-frame and the B-frame. In another example, the packets of the same frame may also have different importance.

In such embodiments, the UE may still receive the ADU related information and the ADU discard information. However, the content included in the ADU related information and the ADU discard information may be different from the formal embodiments.

For example, the ADU related information transmitted by the BS may include: the number of ADU, the numbers of all packets included in the ADU, and an importance indication for each packet included in the ADU. The importance indication may indicate whether the packet is a critical packet or a non-critical packet. For example, the BS may send the mapping between the importance indication and corresponding count value to UE, the importance indication may indicate whether the packet with the count value is a critical packet or a non-critical packet.

In some cases, discarding non-critical packets does not impact the XR service in application layer. In such cases, the BS may indicate to only drop non-critical packets of the ADU. Since the UE knows the ADU related information, the ADU discard information transmitted by the BS may include the number of ADU to be discarded information and critical discard information. The critical discard information is used to indicate whether critical packets need to be discarded or whether only non-critical packets of the ADU need to be discarded.

After receiving the ADU related information and the ADU discard information, in the case that the critical discard information indicates critical packets need not to be discarded or only non-critical packets of the ADU need to be discarded, the UE may discard all stored non-critical packets associated the ADU indicated by the ADU discard information. The UE may also perform the PDCP reordering window management based on the ADU related information and the ADU discard information. For example, performing the PDCP reordering window management may include:
updating an RX_DELIV value to a COUNT value of a first packet which has not been delivered to upper layers but still waited for and is not a non-critical packet of the ADU indicated by the ADU discard information;
updating an RX_NEXT value to a COUNT value of a next packet expected to be received excluding all the non-critical packets of the ADU indicated by the ADU discard information;
restarting a reordering timer in the case that the updated RX_DELIV value is less than the updated RX_NEXT value; and
stopping the reordering timer in the case that the updated RX_DELIV value equals to the updated RX_NEXT value.

For example, referring to FIG. 4, it is assumed that PDCP SDUs with count values #1, #3, #4, and #8 are received at the PDCP layer, whereas PDCP SDUs with count values #2, #5, #6, #7, #9, and #10 are not received at the PDCP layer. Then, RX_NEXT is #9 and RX_DELIV is #2. Since RX_DELIV<RX_NEXT, the UE may start the timer t-Reordering when PDCP SDU with count value #3 is received.

Moreover, it is assumed that the ADU #3 includes PDCP SDUs with count values #2, #3, #4, and #5, wherein PDCP SDUs #2 and #3 are critical and PDCP SDUs #4 and #5 are non-critical. The BS may transmit the ADU related information to the UE, the ADU related information may include the number of the ADU to be discarded (i.e., #3), count values #2, #3, #4, and #5, and the importance indication for each of PDCP SDUs #2, #3, #4, and #5.

When the BS decides to drop all the packets of the ADU, the BS may send the ADU discard information to the UE. The ADU discard information may include the number of ADU to be discarded, i.e., #3 and critical discard information which indicates only non-critical packets of the ADU need to be discarded. After receiving the ADU discard information, the UE may:
determine the count value of packets included in the ADU according to the ADU related information. In this example, the UE determines that the ADU #3 includes PDCP SDUs with count values #2, #3, #4, and #5. Moreover, the UE may further determine the importance of PDCP SDUs #2, #3, #4, and #5 according to the ADU related information, e.g. the PDCP SDUs #2 and #3 are critical and PDCP SDUs #4 and #5 are non-critical in this example.
discard all stored non-critical packets associated the ADU indicated by the ADU discard information, i.e. the PDCP SDU #4 in this example.
update an RX_DELIV value to a COUNT value of a first packet which has not been delivered to upper layers but still waited for and is not a non-critical packet of the ADU indicated by the ADU discard information, i.e., #2 in this example;
update an RX_NEXT value to a COUNT value of a next packet expected to be received excluding all the non-critical packets of the ADU indicated by the ADU discard information, i.e., #9 in this example.
restart the t-Reordering timer because the updated RX_DELIV value is less than the updated RX_NEXT value.

In some embodiments of the present application, an ADU may be served by more than one data radio bearers (DRBs), each DRB may be associated with a corresponding PDCP entity. In such embodiments, the ADU discard information and the ADU related information may impact more than one PDCP entities associated with the ADU of a XR service.

In such embodiments, each PDCP entity may maintain its own PDCP reordering window and perform the PDCP reordering window management respectively. In addition, each PDCP entity may maintain its own numbers of packets. That is, for different packets of one ADU on different PDCP entities, their numbers may be the same or different.

Therefore, when the BS decides to drop some packets of an ADU, the packets to be dropped for each PDCP entity should be indicated to the UE.

For example, the UE may receive the ADU discard information and perform the PDCP reordering window management based on the received ADU discard information. The ADU discard information may include one or more numbers of one or more packets of the ADU for each PDCP entity associated with the ADU. For example, it is assumed that an ADU includes PDCP SDUs with count values #2 and #3 in PDCP entity #1 and PDCP SDUs with count values #1 and #2 in PDCP entity #2, then the ADU discard information may include #2 and #3 for PDCP entity #1 and #1 and #2 for PDCP entity #2. Then, after receiving the ADU discard information, for each PDCP entity, the UE may perform the same operations as in the above embodiments.

In another example, the UE may receive the ADU discard information and ADU related information, and perform the PPDCP reordering window management based on the ADU discard information and the ADU related information. In such embodiment, the ADU related information may include a number of the ADU and numbers of packets of the ADU for each PDCP entity associated with the ADU. For example, it is assumed that an ADU #3 includes PDCP SDUs with count values #2 and #3 in PDCP entity #1 and PDCP SDUs with count values #1 and #2 in PDCP entity #2, then the ADU related information may include the number of ADU to be discarded (i.e., #3), #2 and #3 for PDCP entity #1, and #1 and #2 for PDCP entity #2. The ADU discard information may include the number of the ADU to be discarded. Then, after receiving the ADU discard information and the ADU related information, for each PDCP entity, the UE may perform the same operations as in the above embodiments.

In yet another example, the ADU related information may include a number of an ADU, numbers of packets of the ADU for each PDCP entity associated with the ADU, and importance indication for each packet for each PDCP entity, wherein the importance indication indicates whether the packet is a critical packet or a non-critical packet. For example, it is assumed that an ADU #3 includes PDCP SDUs with count values #2 and #3 in PDCP entity #1 and PDCP SDUs with count values #1 and #2 in PDCP entity #2, the PDCP SDUs with count values #2 and #3 in PDCP entity #1 are critical and PDCP SDUs with count values #1 and #2 in PDCP entity #2 are non-critical, then the ADU related information may include the number of ADU to be discarded (i.e., #3), #2 and #3 for PDCP entity #1, #1 and #2 for PDCP entity #2, and importance indication for each of PDCP SDUs with count values #2 and #3 in PDCP entity #1 and PDCP SDUs with count values #1 and #2 in PDCP entity #2. In such embodiment, the ADU discard information may include the number of the ADU to be discarded and critical discard information which indicates whether critical packets of the ADU need to be discarded or whether only non-critical packets of the ADU need to be discarded. Then, after receiving the ADU discard information and the ADU related information, for each PDCP entity, the UE may perform the same operations as in the above embodiments.

According to some other embodiments of the present application, within an ADU, different packets may have different importance. For example, an ADU of video service can include multiple frames: I-frame (i.e., intra-coded frame), P-frame (i.e., predictive coded picture frame) and B-frame (bi-predictive coded picture frame). Different frame may have different importance, for example, I-frame is more important than the P-frame and the B-frame. In another example, the packets of the same frame may also have different importance. In some cases, discard of non-critical packets does not impact the XR service in application layer, while discard of critical packets will cause critical service interruption of the XR service in application layer. In order to support the more efficient data transmission for XR service which takes a trade-off between reordering and latency into account, separate PDCP winder management schemes for critical and non-critical packets may be designed for XR service in such embodiments.

In such embodiments, the UE may receive the ADU related information without receiving the ADU discard information. The ADU related information may include one number of the ADU, numbers of all the packets included in the ADU, and an importance indication for each packet included in an ADU, wherein the importance indication indicate whether the packet is a critical packet or a non-critical packet. For example, the BS may send the mapping between the importance indication and corresponding count value to UE, the importance indication may indicate whether the packet with the count value is a critical packet or a non-critical packet.

The ADU related information may be received in a layer 2 header, or received via a RRC signalling, or received via a MAC CE, or received via a PDCP control PDU. Then, after receiving the ADU related information, the UE may know the ADU includes which packets or which packets are included in the ADU.

In some embodiments of the present application, separate t-Reordering timers may be defined for critical packets and non-critical packets respectively. For example, the UE may receive a first PDCP reordering window configuration for non-critical packets in the ADU and a second PDCP reordering window configuration for critical packets in the ADU. The first PDCP reordering window configuration may include a first reordering timer (e.g., t-Reordering-Noncritical), and the second PDCP reordering window configuration may include a second reordering timer (e.g., t-Reordering-Critical). In an embodiment of the present application, the first PDCP reordering window configuration and the second PDCP reordering window configuration are configured by an RRC signalling.

After receiving the first reordering timer and the second reordering timer, in the case that a non-critical packet of the ADU is not received and an out of order reception happens to the non-critical packet, the UE may start the first reordering timer; in the case that a critical packet of the ADU is not received and an out of order reception happens to the critical packet, the UE may start the second reordering timer.

When the second reordering timer expiries, the UE may discard all packets of the ADU associated with the critical packet (including both the critical packet and non-critical packet) and move forward the PDCP reordering window. When the first reordering timer expires, the UE may treat the missing non-critical packets as having been received.

For example, in some cases, the critical packet is received when the second reordering timer is running. In such cases, the UE may stop or restart the second reordering timer. In the case that the first reordering timer is running, the UE may update an RX_DELIV value to a COUNT value of a first packet which has not been delivered to upper layers (e.g., the one or more layers higher than PDCP layer) but still waited for. In the case that the first reordering timer expires, the UE may treat all the missing non-critical packets of the ADU as having been received and update an RX_DELIV to a COUNT value of the first packet which has not been delivered to upper layers but still waited for excepting all the packets treated as having been received.

In some other cases, the critical packet is not received when the second reordering timer is running and the second reordering timer expires. In such cases, the UE may stop the first reordering timer and discard all stored packets of the ADU associated with the critical packet.

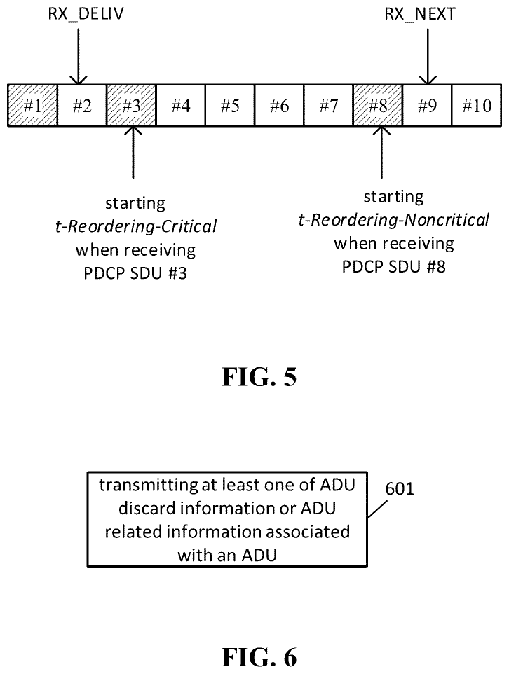

FIG. 5 illustrates another exemplary PDCP reordering management scheme according to some other embodiments of the present application.

Referring to FIG. 5, it is assumed that PDCP SDUs with count values #1, #3, and #8 are received at the PDCP layer, whereas PDCP SDUs with count values #2, #4, #5, #6, #7, #9, and #10 are not received at the PDCP layer. Then, RX_NEXT is #9 and RX_DELIV is #2.

The UE receives ADU related information from the BS, based on the ADU related information, the UE determines that the ADU #3 includes PDCP SDUs with count values #2 to #8, wherein the PDCP SDU #2 is a critical packet and the PDCP SDU #3 to PDCP SDU #8 are non-critical packets. The UE may also receive the timer t-Reordering-Critical for critical packets and the timer t-Reordering-Noncritical for non-critical packets.

After receiving the ADU related information and the above two timers, since RX_DELIV<RX_NEXT, and the critical packet PDCP SDU #2 is still waited for, the UE starts the timer t-Reordering-Critical when it receives PDCP SDU #3. In addition, since RX_DELIV<RX_NEXT and the non-critical PDCP SDU #4 is still waited for, the UE starts the timer t-Reordering-Noncritical when it receives PDCP SDU #8. Under these circumstances, one of the following two cases may occur.

### Case 1:

If the PDCP SDU #2 is received when the t-Reordering-Critical is running, the UE may:
stop or restart the timer t-Reordering-Critical,
if the timer t-Reordering-Noncritical is running,
   update the RX_DELIV value to a COUNT value of a first packet which has not been delivered to upper layers but still waited for, i.e. PDCP SDU #4 in this case.
if the timer t-Reordering-Noncritical expires:
   treat all the missing non-critical packets of the ADU as ‘discarded’ or ‘have been received’
   update the RX_DELIV to the COUNT value of the first packet which has not been delivered to upper layers but still waited for excepting the packets that are treated as ‘discarded’ or ‘have been received’, i.e. PDCP SDU #9 in this case.

### Case 2:

If the PDCP SDU #2 is not received, the UE may
if the timer t-Reordering-Critical expires:
   stop the timer t-Reordering-Noncritical, if running.
   discard all stored PDCP SDUs (i.e., PDCP SDU #3 and #8) of the ADU associated with the critical packet.

In some other embodiments of the present application, the second reordering timer is set to zero. In such embodiments, the UE may deliver a critical packet directly to upper layers when receiving it from lower layers (e.g., the one or more layers lower than PDCP layer) without performing a PDCP reordering window management for the critical packet. In other words, the UE may perform PDCP reordering window management except for the critical packets.

In some other embodiments of the present application, the second reordering timer for critical packets in the ADU is absent. That is, the UE may only receive a first PDCP reordering window configuration for non-critical packets in the ADU. The first PDCP reordering window configuration may include a first reordering timer (e.g., t-Reordering-Noncritical). In such embodiments, the UE may deliver a critical packet directly to upper layers when receiving it from lower layers without performing a PDCP reordering window management for the critical packet. In other words, the UE may perform PDCP reordering window management except for the critical packets.

In some other embodiments of the present application, not only PDCP reordering timers but also state variables are separate for critical packets and non-critical packets, respectively. In such cases, the UE may receive a first PDCP reordering window configuration for non-critical packets in the ADU and a second PDCP reordering window configuration for critical packets in the ADU. The first PDCP reordering window configuration may include a first reordering timer (e.g., t-Reordering-Noncritical), a first RX_DELIV value and a first RX_NEXT value for the non-critical packets, and the second PDCP reordering window configuration may include a second reordering timer (e.g., t-Reordering-Critical), a second RX_DELIV value, and a second RX_NEXT value for the critical packets. After receiving the first PDCP reordering window configuration and the second PDCP reordering window configuration, the UE may perform the PDCP reordering window management for the critical packets and the non-critical packets, separately.

Although the embodiments in FIGS. 2, 4, and 5 take PDCP SDU as an example for description, it is contemplated that the PDCP SDU may be replaced with a PDCP PDU in some other embodiments of the present application. Although the embodiments in FIGS. 2, 4, and 5 take count value as an example for description, it is contemplated that the count value may be replaced with a SN in some other embodiments of the present application.

FIG. 6 illustrates another exemplary flowchart of a method for PDCP reordering management according to some embodiments of the present application. The method illustrated in FIG. 6 may be performed by a BS (e.g., the BS 101 as shown in FIG. 1). Persons skilled in the art can understand that the method described with respect to the BS can be implemented by other apparatus with the like functions.

In the exemplary embodiments shown in FIG. 6, in step 601, the BS may transmit at least one of ADU discard information associated with an ADU or ADU related information associated with the ADU to a UE (e.g., UE 101a or UE 101b as shown in FIG. 1) The transmitted at least one of the ADU discard information or the ADU related information may be used for performing a PDCP reordering window management by the UE. That is, after receiving the at least one of the ADU discard information or the ADU related information, the UE may perform the PDCP reordering window management as illustrated in the embodiments of FIG. 3.

In some embodiments of the present application, the ADU discard information may be transmitted via a RRC signalling or transmitted via a PDCP control PDU, e.g., the ADU discard information may be transmitted in a PDCP SDU discard command.

In some embodiments of the present application, the ADU discard information includes one or more numbers of one or more packets of the ADU. In such embodiments, the BS may not transmit the ADU related information.

In an embodiment of the present application, a packet of the ADU may be a PDCP PDU or a PDCP SDU. In another embodiment of the present application, a number of a packet may be a PDCP SN or a PDCP count value.

In some other embodiments of the present application, the BS may transmit both the ADU related information and the ADU discard information. The ADU related information may include one number of the ADU and numbers of all the packets included in the ADU. The number of the ADU may be a sequence number of the ADU or any other number of the ADU which can be used to identify the ADU. A number of a packet in ADU may be a SN of the packet of a count value of the packet.

In an embodiments of the present application, the ADU related information may be transmitted in a layer 2 header (e.g., in a radio link control (RLC) header or a PDCP header or a MAC header), or transmitted via a RRC signalling, or transmitted via a MAC CE, or transmitted via a PDCP control PDU. In such embodiments, the ADU discard information transmitted by the BS may merely include the number of the ADU to be discarded.

In some other embodiments of the present application, the BS may transmit the ADU related information and the ADU discard information. The ADU related information transmitted by the BS may include: the number of ADU, the numbers of all packets included in the ADU, and an importance indication for each packet included in the ADU. The importance indication may indicate whether the packet is a critical packet or a non-critical packet. The ADU discard information transmitted by the BS may include the number of ADU to be discarded information and critical discard information. The critical discard information is used to indicate whether critical packets need to be discarded or whether only non-critical packets of the ADU need to be discarded.

In some embodiments of the present application, an ADU may be served by more than one data radio bearers (DRBs), each DRB may be associated with a corresponding PDCP entity. In such embodiments, the ADU discard information and the ADU related information may include the same content as that included in the embodiments in FIG. 3, and the BS may perform the same operations as those performed by the UE in the embodiments in FIG. 3.

According to some other embodiments of the present application, within an ADU, different packets may have different importance. For example, an ADU of video service can include multiple frames: I-frame (i.e., intra-coded frame), P-frame (i.e., predictive coded picture frame) and B-frame (bi-predictive coded picture frame). Different frame may have different importance, for example, I-frame is more important than the P-frame and the B-frame. In another example, the packets of the same frame may also have different importance. In some cases, discard of non-critical packets does not impact the XR service in application layer, while discard of critical packets will cause critical service interruption of the XR service in application layer. In order to support the more efficient data transmission for XR service which takes a trade-off between reordering and latency into account, separate PDCP winder management schemes for critical and non-critical packets may be designed for XR service in such embodiments.

In such embodiments, the BS may transmit the ADU related information without transmitting the ADU discard information. The ADU related information may include one number of the ADU, numbers of all the packets included in the ADU, and an importance indication for each packet included in an ADU, wherein the importance indication indicate whether the packet is a critical packet or a non-critical packet. The ADU related information may be transmitted in a layer 2 header, or transmitted via a RRC signalling, or transmitted via a MAC CE, or transmitted via a PDCP control PDU.

In some embodiments of the present application, separate t-Reordering timers may be defined for critical packets and non-critical packets respectively. For example, the BS may transmit a first PDCP reordering window configuration for non-critical packets in the ADU and a second PDCP reordering window configuration for critical packets in the ADU. The first PDCP reordering window configuration may include a first reordering timer (e.g., t-Reordering-Noncritical), and the second PDCP reordering window configuration may include a second reordering timer (e.g., t-Reordering-Critical). In an embodiment of the present application, the first PDCP reordering window configuration and the second PDCP reordering window configuration are configured by an RRC signalling.

In some other embodiments of the present application, the second reordering timer is set to zero.

In some other embodiments of the present application, the second reordering timer for critical packets in the ADU is absent.

In some other embodiments of the present application, not only PDCP reordering timers but also state variables are separate for critical packets and non-critical packets, respectively. In such cases, the BS may transmit a first PDCP reordering window configuration for non-critical packets in the ADU and a second PDCP reordering window configuration for critical packets in the ADU. The first PDCP reordering window configuration may include a first reordering timer (e.g., t-Reordering-Noncritical), a first RX_DELIV value and a first RX_NEXT value for the non-critical packets, and the second PDCP reordering window configuration may include a second reordering timer (e.g., t-Reordering-Critical), a second RX_DELIV value, and a second RX_NEXT value for the critical packets. After transmitting the first PDCP reordering window configuration and the second PDCP reordering window configuration, the BS may perform the PDCP reordering window management for the critical packets and the non-critical packets, separately.

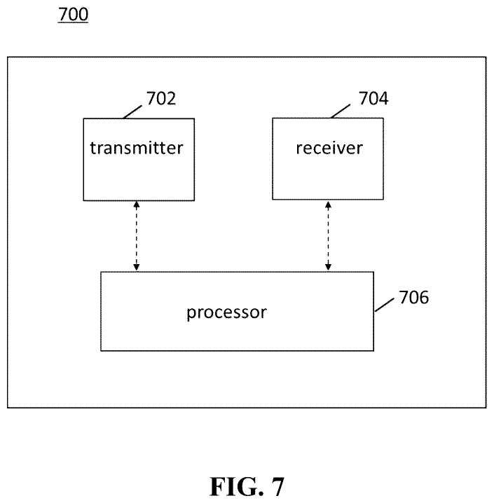

FIG. 7 illustrates a simplified block diagram of an apparatus for PDCP reordering management according to some embodiments of the present application.

Referring to FIG. 7, the apparatus 700 may include at least one transmitter 702, at least one receiver 704, and at least one processor 706. The at least one transmitter 702 is coupled to the at least one processor 706, and the at least one receiver 704 is coupled to the at least one processor 706.

Although in this figure, elements such as the transmitter 702, the receiver 704, and the processor 706 are illustrated in the singular, the plural is contemplated unless a limitation to the singular is explicitly stated. In some embodiments of the present application, the transmitter 702 and the receiver 704 may be combined to one device, such as a transceiver. In some embodiments of the present application, the apparatus 700 may further include an input device, a memory, and/or other components. The transmitter 702, the receiver 704, and the processor 706 may be configured to perform any of the methods described herein (e.g., the method described with respect to any of FIGS. 3-6).

According to some embodiments of the present application, the apparatus 700 may be a UE. In some embodiments of the present application, the receiver 704 is configured to receive at least one of ADU discard information associated with an ADU or ADU related information associated with the ADU; and the processor 706 is configured to perform a PDCP reordering window management based on the received at least one of the ADU discard information or the ADU related information.

In some embodiments of the present application, the ADU discard information is received via an RRC signalling or received via a PDCP control PDU.

In some embodiments of the present application, the ADU discard information includes one or more numbers of one or more packets of the ADU.

In some embodiments of the present application, a number of a packet is a PDCP SN or a PDCP count value.

In some embodiments of the present application, wherein the processor 706 is further configured to discard all stored packets with numbers included in the ADU discard information, and wherein the processor 706 is further configured to: update an RX_DELIV value to a COUNT value of a first packet which has not been delivered to upper layers but still waited for and is not indicated to be discarded by the ADU discard information; update an RX_NEXT value to a COUNT value of a next packet expected to be received excluding the one or more packets that are indicated to be discarded by the ADU discard information; restart a reordering timer in the case that the updated RX_DELIV value is less than the updated RX_NEXT value; and stop the reordering timer in the case that the updated RX_DELIV value equals to the updated RX_NEXT value.

In some embodiments of the present application, the ADU related information includes one number of the ADU and numbers of all the packets included in the ADU, and wherein the ADU discard information includes the number of the ADU to be discarded.

In some embodiments of the present application, wherein the processor 706 is further configured to discard all stored packets associated with the ADU indicated by the ADU discard information, and the processor 706 is further configured to: update an RX_DELIV value to a COUNT value of a first packet which has not been delivered to upper layers but still waited for and is not a part of the ADU indicated by the ADU discard information; update an RX_NEXT value to a COUNT value of a next packet expected to be received excluding all the packets which are part of the ADU indicated by the ADU discard information; restart a reordering timer in the case that the updated RX_DELIV value is less than the updated RX_NEXT value; and stop the reordering timer in the case that the updated RX_DELIV value equals to the updated RX_NEXT value.

In some embodiments of the present application, wherein the ADU related information further includes an importance indication for each packet included in the ADU, wherein the importance indication indicates whether the packet is a critical packet or a non-critical packet, and wherein the ADU discard information includes the number of the ADU to be discarded and critical discard information which indicates whether critical packets of the ADU need to be discarded or whether only non-critical packets of the ADU need to be discarded.

In some embodiments of the present application, wherein the processor 706 is further configured to discard all stored non-critical packets associated the ADU indicated by the ADU discard information in the case that the critical discard information indicates only non-critical packets of the ADU need to be discarded, and wherein the processor 706 is further configured to: update an RX_DELIV value to a COUNT value of a first packet which has not been delivered to upper layers but still waited for and is not a non-critical packet of the ADU indicated by the ADU discard information; update an RX_NEXT value to a COUNT value of a next packet expected to be received excluding all the non-critical packets of the ADU indicated by the ADU discard information; restart a reordering timer in the case that the updated RX_DELIV value is less than the updated RX_NEXT value; and stop the reordering timer in the case that the updated RX_DELIV value equals to the updated RX_NEXT value.

In some embodiments of the present application, the ADU related information is received in a layer 2 header, or received via an RRC signalling, or received via a MAC CE, or received via a PDCP control PDU.

In some embodiments of the present application, the ADU related information includes one number of the ADU, numbers of all the packets included in the ADU, and an importance indication for each packet included in an ADU, wherein the importance indication indicate whether the packet is a critical packet or a non-critical packet.

In some embodiments of the present application, the receiver 704 is further configured to: receive a first PDCP reordering window configuration for non-critical packets in the ADU, wherein the first PDCP reordering window configuration includes a first reordering timer.

In some embodiments of the present application, the receiver 704 is further configured to: receive a second PDCP reordering window configuration for critical packets in the ADU, wherein the first PDCP reordering window configuration includes a second reordering timer.

In some embodiments of the present application, the processor 706 is further configured to: start a first reordering timer in the case that a non-critical packet of the ADU is not received and an out of order reception happens to the non-critical packet; start a second reordering timer in the case that a critical packet of the ADU is not received and an out of order reception happens to the critical packet.

In some embodiments of the present application, in the case that the critical packet is received when the second reordering timer is running, the processor 706 is further configured to: stop or restart the second reordering timer; in the case that the first reordering timer is running: update an RX_DELIV value to a COUNT value of a first packet which has not been delivered to upper layers but still waited for; and in the case that the first reordering timer expires: treat all the missing non-critical packets of the ADU as having been received; and update an RX_DELIV to a COUNT value of the first packet which has not been delivered to upper layers but still waited for excepting all the packets treated as having been received.

In some embodiments of the present application, in the case that the critical packet is not received and the second reordering timer expires, the processor 706 is further configured to: stop the first reordering timer; and discard all stored packets of the ADU associated with the critical packet.

In some embodiments of the present application, the second reordering timer is set to zero.

In some embodiments of the present application, a second reordering timer for critical packets in the ADU is absent.

In some embodiments of the present application, the processor 706 is further configured to: deliver a critical packet directly to upper layers when receiving it from lower layers without performing a PDCP reordering window management for the critical packet.

In some embodiments of the present application, the first PDCP reordering window configuration further includes a first RX_DELIV value and a first RX_NEXT value, and wherein the second PDCP reordering window configuration further includes a second RX_DELIV value and a second RX_NEXT value.

According to some embodiments of the present application, the apparatus 700 may be a BS. In some embodiments of the present application, the transmitter 702 is configured to transmit at least one of ADU discard information associated with an ADU or ADU related information associated with the ADU The transmitted at least one of the ADU discard information or the ADU related information may be used for performing a PDCP reordering window management.

In some embodiments of the present application, the ADU discard information is transmitted via an RRC signalling or transmitted via a PDCP control PDU.

In some embodiments of the present application, the ADU discard information includes one or more numbers of one or more packets of the ADU.

In some embodiments of the present application, a number of a packet is a PDCP SN or a PDCP count value.

In some embodiments of the present application, the ADU related information includes one number of the ADU and numbers of all the packets included in the ADU, and wherein the ADU discard information includes the number of the ADU to be discarded.

In some embodiments of the present application, wherein the ADU related information further includes an importance indication for each packet included in the ADU, wherein the importance indication indicates whether the packet is a critical packet or a non-critical packet, and wherein the ADU discard information includes the number of the ADU to be discarded and critical discard information which indicates whether critical packets of the ADU need to be discarded or whether only non-critical packets of the ADU need to be discarded.

In some embodiments of the present application, the ADU related information is transmitted in a layer 2 header, or transmitted via an RRC signalling, or transmitted via a MAC CE, or transmitted via a PDCP control PDU.

In some embodiments of the present application, the ADU related information includes one number of the ADU, numbers of all the packets included in the ADU, and an importance indication for each packet included in an ADU, wherein the importance indication indicate whether the packet is a critical packet or a non-critical packet.

In some embodiments of the present application, the transmitter 702 is further configured to: transmit a first PDCP reordering window configuration for non-critical packets in the ADU, wherein the first PDCP reordering window configuration includes a first reordering timer.

In some embodiments of the present application, the transmitter 702 is further configured to: transmit a second PDCP reordering window configuration for critical packets in the ADU, wherein the first PDCP reordering window configuration includes a second reordering timer.

In some embodiments of the present application, the second reordering timer is set to zero.

In some embodiments of the present application, a second reordering timer for critical packets in the ADU is absent.

In some embodiments of the present application, the first PDCP reordering window configuration further includes a first RX_DELIV value and a first RX_NEXT value, and wherein the second PDCP reordering window configuration further includes a second RX_DELIV value and a second RX_NEXT value.

In some embodiments of the present application, the apparatus 700 may further include at least one non-transitory computer-readable medium. In some embodiments of the present disclosure, the non-transitory computer-readable medium may have stored thereon computer-executable instructions to cause the processor 706 to implement any of the methods as described above. For example, the computer-executable instructions, when executed, may cause the processor 706 to interact with the transmitter 702 and/or the receiver 704, so as to perform operations of the methods, e.g., as described with respect to FIGS. 3-6.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for PDCP reordering management, including a processor and a memory. Computer programmable instructions for implementing a method for PDCP reordering management are stored in the memory, and the processor is configured to perform the computer programmable instructions to implement the method for PDCP reordering management. The method for PDCP reordering management may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for PDCP reordering management according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE), comprising:
at least one memory; and
at least one processor coupled to the at least one memory and configured to cause the UE to:
receive application data unit (ADU) discard information associated with an ADU or ADU related information associated with the ADU; and
perform a packet data convergence protocol (PDCP) reordering window management based on the received ADU discard information or the received ADU related information.

2. The UE of claim 1, wherein the ADU discard information includes one or more numbers of one or more packets of the ADU.

3. The UE of claim 1, wherein the at least one processor is further configured to cause the UE to:
discard all stored packets with numbers included in the ADU discard information;
update an RX_DELIV value to a COUNT value of a first packet that has not been delivered to upper layers and is not indicated to be discarded by the ADU discard information;
update an RX_NEXT value to a COUNT value of a next packet expected to be received excluding one or more packets indicated to be discarded by the ADU discard information;
restart a reordering timer when the updated RX_DELIV value is less than the updated RX_NEXT value; and
stop the reordering timer when the updated RX_DELIV value equals the updated RX_NEXT value.

4. The UE of claim 1, wherein the ADU related information includes one number of the ADU and numbers of all packets included in the ADU, and wherein the ADU discard information includes the number of the ADU to be discarded.

5. The UE of claim 4, wherein the at least one processor is further configured to cause the UE to:
discard all stored packets associated with the ADU indicated by the ADU discard information;
update an RX_DELIV value to a COUNT value of a first packet that has not been delivered to upper layers and is not a part of the ADU indicated by the ADU discard information;
update an RX_NEXT value to a COUNT value of a next packet expected to be received excluding all packets that are part of the ADU indicated by the ADU discard information;
restart a reordering timer when the updated RX_DELIV value is less than the updated RX_NEXT value; and
stop the reordering timer when the updated RX_DELIV value equals the updated RX_NEXT value.

6. The UE of claim 4, wherein the ADU related information includes an importance indication for each packet included in the ADU, wherein the importance indication indicates whether each packet is a critical packet or a non-critical packet, and wherein the ADU discard information includes the number of the ADU to be discarded and critical discard information that indicates whether critical packets of the ADU are to be discarded or whether only non-critical packets of the ADU are not to be discarded.

7. The UE of claim 6, wherein the at least one processor is further configured to cause the UE to:
discard all stored non-critical packets associated with the ADU indicated by the ADU discard information when the critical discard information indicates only non-critical packets of the ADU are to be discarded;
update an RX_DELIV value to a COUNT value of a first packet that has not been delivered to upper layers and is not a non-critical packet of the ADU indicated by the ADU discard information;
update an RX_NEXT value to a COUNT value of a next packet expected to be received excluding all non-critical packets of the ADU indicated by the ADU discard information;
restart a reordering timer when the updated RX_DELIV value is less than the updated RX_NEXT value; and
stop the reordering timer when the updated RX_DELIV value equals the updated RX_NEXT value.

8. The UE of claim 1, wherein the ADU related information includes one number of the ADU, numbers of all packets included in the ADU, and an importance indication for each packet included in the ADU, wherein the importance indication indicates whether each packet is a critical packet or a non-critical packet.

9. The UE of claim 8, wherein the at least one processor is further configured to cause the UE to:
receive a first PDCP reordering window configuration for non-critical packets in the ADU, wherein the first PDCP reordering window configuration includes a first reordering timer.

10. The UE of claim 9, wherein the at least one processor is further configured to cause the UE to:
receive a second PDCP reordering window configuration for critical packets in the ADU, wherein the second PDCP reordering window configuration includes a second reordering timer.

11. The UE of claim 10, wherein the at least one processor is further configured to cause the UE to:
start a first reordering timer when a non-critical packet of the ADU is not received and an out of order reception occurs with the non-critical packet; and
start a second reordering timer when a critical packet of the ADU is not received and an out of order reception occurs with the critical packet.

12. The UE of claim 11, wherein, when the critical packet is received when the second reordering timer is running, the at least one processor is further configured to cause the UE to:
stop or restart the second reordering timer;
wherein, when the critical packet is received when the first reordering timer is running, the at least one processor is further configured to cause the UE to:
update an RX_DELIV value to a COUNT value of a first packet that has not been delivered to upper layers; and
wherein, when the first reordering timer expires:
consider all missing non-critical packets of the ADU as having been received; and
update an RX_DELIV to a COUNT value of the first packet that has not been delivered to upper layers, except for the missing non-critical packets considered as having been received.

13. The UE of claim 11, wherein, when the critical packet is not received and the second reordering timer expires, the at least one processor is further configured to cause the UE to:
stop the first reordering timer; and
discard all stored packets of the ADU associated with the critical packet.

14. The UE of claim 10, wherein the first PDCP reordering window configuration further includes a first RX_DELIV value and a first RX_NEXT value, and wherein the second PDCP reordering window configuration further includes a second RX_DELIV value and a second RX_NEXT value.

15. A method performed by a user equipment (UE), the method comprising:
receiving application data unit (ADU) discard information associated with an ADU or ADU related information associated with an ADU; and
performing a packet data convergence protocol (PDCP) reordering window management based on the received ADU discard information or the received ADU related information.

16. The method of claim 15, wherein the ADU discard information includes one or more numbers of one or more packets of the ADU.

17. The method of claim 15, further comprising:
discarding all stored packets with numbers included in the ADU discard information;
updating an RX_DELIV value to a COUNT value of a first packet that has not been delivered to upper layers and is not indicated to be discarded by the ADU discard information;
updating an RX_NEXT value to a COUNT value of a next packet expected to be received excluding one or more packets indicated to be discarded by the ADU discard information;
restarting a reordering timer when the updated RX_DELIV value is less than the updated RX_NEXT value; and
stopping the reordering timer when the updated RX_DELIV value equals the updated RX_NEXT value.

18. A processor for wireless communication, comprising:
at least one controller coupled with at least one memory and configured to cause the processor to:
receive application data unit (ADU) discard information associated with an ADU or ADU related information associated with the ADU; and
perform a packet data convergence protocol (PDCP) reordering window management based on the received ADU discard information or the received ADU related information.

19. The processor of claim 18, wherein the ADU discard information includes one or more numbers of one or more packets of the ADU.

20. The processor of claim 18, wherein the at least one controller is further configured to cause the processor to:
discard all stored packets with numbers included in the ADU discard information;
update an RX_DELIV value to a COUNT value of a first packet that has not been delivered to upper layers and is not indicated to be discarded by the ADU discard information;
update an RX_NEXT value to a COUNT value of a next packet expected to be received excluding one or more packets indicated to be discarded by the ADU discard information;
restart a reordering timer when the updated RX_DELIV value is less than the updated RX_NEXT value; and
stop the reordering timer when the updated RX_DELIV value equals the updated RX_NEXT value.
